(19) United States
(12) Patent Application Publication
(10) Pub. No.: US 2015/0200776 A1
(43) Pub. Date: Jul. 16, 2015

(54) PORTABLE ELECTRONIC DEVICE AND SECURE PAIRING METHOD THEREFOR

(71) Applicant: INDUSTRIAL TECHNOLOGY RESEARCH INSTITUTE, Hsinchu (TW)

(72) Inventors: Shi-Wei Kao, Hsinchu (TW); Tien-Yen Ma, Hsinchu (TW)

(73) Assignee: INDUSTRIAL TECHNOLOGY RESEARCH INSTITUTE, Hsinchu (TW)

(21) Appl. No.: 14/287,400

(22) Filed: May 27, 2014

(30) Foreign Application Priority Data
Jan. 15, 2014 (TW) 103101387

(51) Int. Cl. H04L 9/08

(52) U.S. Cl. CPC H04L 9/0844; H04L 9/0869; H04L 2209/24

(57) ABSTRACT

A portable electronic device includes a first sensor that senses a motion state of the first portable electronic device and generates first motion state information, a second sensor that senses a motion state of another portable electronic device and generates second motion state information, a communication unit that receives another session key and third motion state information that indicates a motion state of the another portable electronic device sensed by the another portable electronic device, and a control unit that compares the second and third motion state information, enables the first and second sensors to sense the motion states of the portable electronic devices, processes the motion states and generate a session key, authenticates whether the session key is matched with the another session key, and enables the communication unit to communicate with the another portable electronic device if the session key is matched with the another session key.

### CROSS-REFERENCE TO RELATED APPLICATION

This application claims foreign priority under 35 U.S.C. §119(a) to Patent Application No. 103101387, filed on Jan. 15, 2014, in the Intellectual Property Office of Ministry of Economic Affairs, Republic of China (Taiwan, R.O.C.), the entire content of which Patent Application is incorporated herein by reference.

### BACKGROUND OF THE INVENTION

1. Technical Field

This disclosure relates to a portable electronic device and a secure pairing method for the portable electronic device.

2. Background

When two portable electronic devices are going to be in near-field wireless communication, a secure pairing has to be established there between in advance. For instance, two portable electronic devices may perform a mutual authentication process by shared secrets, and thus establish a security channel.

If the two portable electronic devices do not have any secrets to be shared with each other, a key agreement (e.g., Diffie-Hellman Key Exchange) has to be performed to generate a shared key. Therefore, the two portable electronic devices may use the shared key to establish a secure connection there between. However, such a secure connection established by the key agreement process is easily to be eavesdropped and intercepted, and is vulnerable by the Man-in-the-middle Attack.

Therefore, how to establish secure connection between two portable electronic devices that have no shared secrets that is immune from the Man-in-the-middle Attack is becoming an urgent issue in the art.

### SUMMARY OF THE INVENTION

The present disclosure provides a portable electronic device, comprising: a first sensor that senses a motion state of the portable electronic device and generates first motion state information; a second sensor that senses a motion state of another portable electronic device and generates second motion state information; a communication unit that outputs the first motion state information to the another portable electronic device and receives third motion state information and another session key output by the another portable electronic device, wherein the third motion state information indicates a motion state of the another portable electronic device sensed by the another portable electronic device; and a control unit that compares the second motion state information with the third motion state information, enables the first and second sensors to sense the motion states of the portable electronic device and the another portable electronic device, respectively, if the second motion state information is matched with the third motion state information, processes the motion states and generates a session key, authenticates whether the session key is matched with the another session key, and enables the communication unit to communicate with another communication unit of the another portable electronic device if the session key is matched with the another session key.

The present disclosure further provides a secure pairing method for a portable electronic device, comprising the followings steps of: (1) enabling a first portable electronic device to sense a motion state of the portable electronic device, generate first motion state information and output the first motion state information to a second portable electronic device, enabling the first portable electronic device to sense a motion state of the second portable electronic device and generate second motion state information, enabling the second portable electronic device to sense a motion state of the second portable electronic device, generate third motion state information and output the third motion state information to the first portable electronic device, and enabling the second portable electronic device to sense a motion state of the first portable electronic device and generate fourth motion state information; (2) enabling the first portable electronic device to receive the third motion state information, and enabling the second portable electronic device to receive the first motion state information; (3) enabling the first portable electronic device to compare the second motion state information with the third motion state information, and enabling the second portable electronic device to compare the fourth motion state information with the first motion state information; (4) enabling the first portable electronic device to sense the motion states of the first and second portable electronic devices, when the second motion state information is matched with the third motion state information, process the motion states, and generate a first session key, and enabling the second portable electronic device to sense the motion states of the second and first portable electronic devices, when the fourth motion state information is matched with the first motion state information, process the motion states, and generate a second session key; and (5) enabling the first and the second portable electronic devices to authenticate whether the first session key is matched with the second session key, and enabling the first and second portable electronic devices to communicate with each other.

### BRIEF DESCRIPTION OF THE DRAWINGS

The disclosure can be more fully understood by reading the following detailed description of the preferred embodiments, with reference made to the accompanying drawings.

FIG. 1 is a functional block diagram of a portable electronic device according to the present disclosure.

FIG. 2 is a flow chart illustrating a handshaking authentication stage of a secure pairing method for a portable electronic device according to the present disclosure.

FIG. 3 is a flow chart illustrating a session key generation stage of a secure pairing method for a portable electronic device according to the present disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

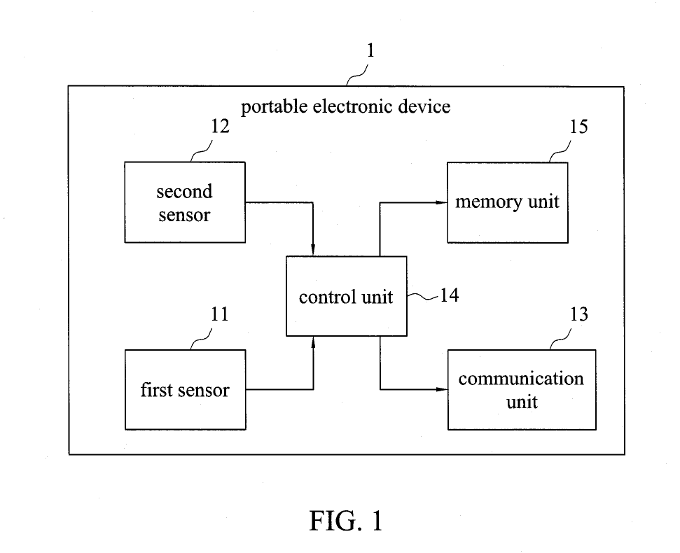

FIG. 1 is a functional block diagram of a portable electronic device 1 according to the present disclosure. The portable electronic device 1 comprises a first sensor 11, a second sensor 12, a communication unit 13, a control unit 14 and a memory unit 15.

The first sensor 11 senses a motion state of the portable electronic device 1 and generate first motion state information. The first motion state information is recorded in the memory unit 15. In an embodiment, the first sensor 11 is an inertia sensor, such as an accelerator and a gyroscope. The first motion state information indicates motions of the portable electronic device 1 in a three-dimension space.

The second sensor 12 senses a motion state of another portable electronic device and generates second motion state information. The second motion state information is recorded in the memory unit 15. In an embodiment, the second sensor 12 is an optical sensor such as a depth image sensor. When the portable electronic device 1 is ready to sense the motion state of the another portable electronic device, the depth image sensor has to point at the another portable electronic device.

The communication unit 13 outputs the first motion state information to the another portable electronic device, and receives the third motion state output by the portable electronic device that indicates a motion state of the another portable electronic device sensed by the another portable electronic device. The third motion state information is also recorded in the memory unit 15. In an embodiment, the communication unit 13 is a wireless communication unit such as a near field communication (NFC) unit.

The control unit 14 obtains the second motion state information and the third motion state information from the memory unit 15, compares the second motion state information with the third motion state information to determine whether the second motion state information is matched with the third motion state information. The second motion state information indicates a motion state obtained from the portable electronic device 1 by sensing the another portable electronic device. The third motion state information indicates a motion state of the another portable electronic device sensed by the another portable electronic device. The portable electronic device 1 can thus determine whether a communication object with which the communication unit 13 is communicating is what the second sensor 12 points at, by comparing the sensed one and the received one and determining whether the sensed one is matched with the received one. Since the motion state of the another portable electronic device sensed by the second sensor 12 is corresponding to the motion state of the portable electronic device 1, the control unit 14 has to transform a reference coordinate of the second motion state information before comparing the second motion state information with the third motion state information. If the second motion state information is matched with the third motion state information, the communication object with which the communication unit 13 is communicating is indeed what the second sensor 12 points at.

The control unit 14, after determining that the second motion state information is matched with the third motion state information, employs a Hashing function to process the motion state of the portable electronic device 1 sensed by the first sensor 11 and generate a first random number, and process the motion state of the another portable electronic device sensed by the second sensor 12 and generate a second random number, and connects the first random number in series with the second random number to generate a session key. In a similar fashion, the another portable electronic device also generates another session key. The portable electronic device 1 then employs a challenge-response authentication process to authenticate whether the session key is matched with the another session key, and communicates with the another portable electronic device after it is authenticated that the session key is matched with the another session key. The challenge-response authentication process is well-known in the art, further description thereof hereby omitted.

The portable electronic device 1 uses the first sensor 11 and the second sensor 12 to perform a secure pairing with the another portable electronic device, though the portable electronic device 1 and the another portable electronic device do not have shared secrets, and their secure connection is immune from the Man-in-the-middle Attack.

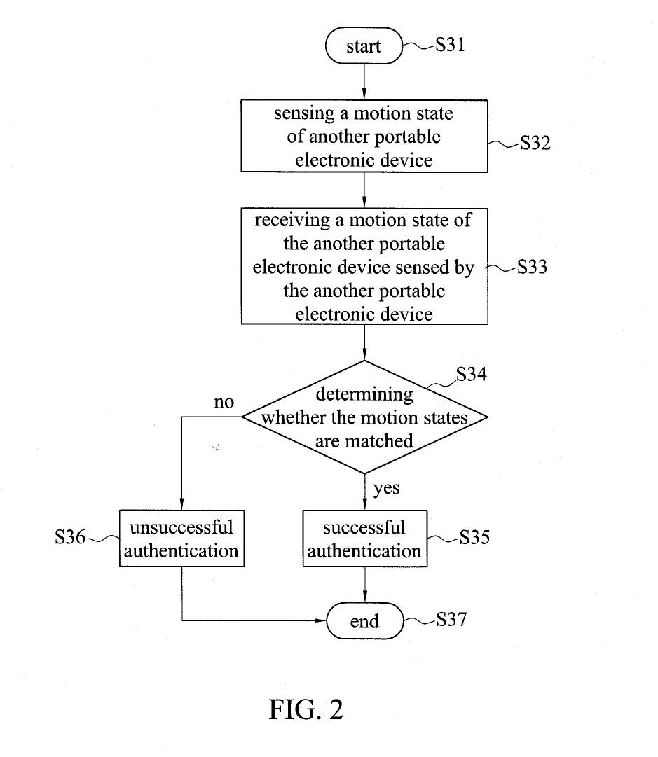

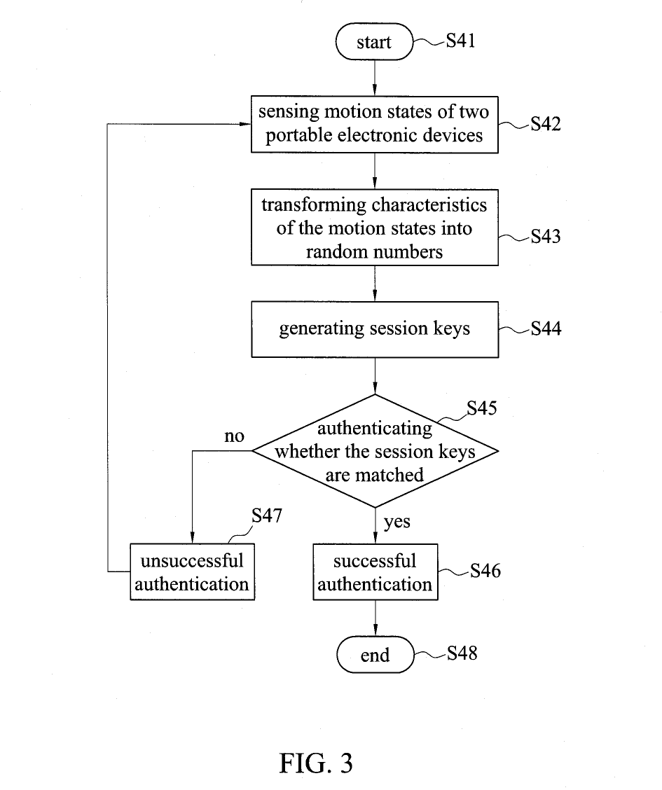

FIGS. 2 and 3 illustrate a secure pairing method for a portable electronic device according to the present disclosure. FIG. 2 is a flow chart illustrating a handshaking authentication stage of a secure pairing method for a portable electronic device according to the present disclosure. FIG. 3 is a flow chart illustrating a session key generation stage of a secure pairing method for a portable electronic device according to the present disclosure.

As shown in FIG. 2, in step S31 a handshaking authentication process is performed.

In step S32, a motion state of another portable electronic device is sensed. In practice, a first portable electronic device senses a motion state of the first portable electronic device, generates first motion state information, and outputs the first motion state information to a second portable electronic device. The first portable electronic device further senses a motion state of the second portable electronic device and generates second motion state information. The second portable electronic device senses a motion state of the second portable electronic device, generates third motion state information, and outputs the third motion state information to the first portable electronic device. The second portable electronic device further senses a motion state of the first portable electronic device, and generates fourth motion state information.

In step S33, the first and second portable electronic devices received the motion states from the second and first portable electronic devices, respectively. In practice, the first portable electronic device receives the third motion state information output from the second portable electronic device, and the second portable electronic device receives the first motion state information output from the first portable electronic device.

In step S34, the sensed one and the received one are compared to determine whether they are matched. In practice, the first portable electronic device compares the second motion state information with the third motion state information, and the second portable electronic device compares the fourth motion state information with the first motion state information. If the second motion state information is matched with the third motion state information and the fourth motion state information is matched with the first motion state information, step S35 is performed, which indicates successful authentication, or step S37 is performed, which ends the handshaking authentication process. If the second motion state information is not matched with the third motion state information or the fourth motion state information is not matched with the first motion state information, steps S36 and S37 are performed sequentially. Step S36 indicates unsuccessful authentication. Since the motion state of the second portable electronic device sensed by the first portable electronic device is corresponding to the motion state of the first portable electronic device, a reference coordinate of the second motion state information has to be transformed to be in the same coordinate system as a reference coordinate of the third motion state information before the second motion state information is compared with the third motion state information. The second portable electronic device also has to perform the same process.

After the successful authentication and the handshaking authentication process shown in FIG. 2, a session key generation process shown in FIG. 3 is performed.

As shown in FIG. 3, in step S41, a session key generation process is performed.

In step S42, the motion states of the first and second portable electronic devices are sensed. In practice, the first portable electronic device senses motion states of the first and second portable electronic devices, and the second portable electronic device senses motion states of the second and first portable electronic devices.

In step S43, the characteristics of the motion states of the first and second portable electronic devices are transformed into random numbers. In practice, the first portable electronic device processes the motion state of the first portable electronic device and employs a Hashing function to generate a first random number, and processes the motion state of the another portable electronic device and employs the Hashing function to generate a second random number; the second portable electronic device processes the motion state of the second portable electronic device and employs the Hashing function to generate a third random number, and processes the motion state of the first portable electronic device and employs the Hashing function to generate a fourth random number.

In step S44, session keys are generated. In practice, the first portable electronic device employs a specific mode to combine the first random number with the second random number (e.g., connecting the first random number in series with the second random number) and generates a first session key; and the second portable electronic device employs the specific mode to combine the third random number and the fourth random number to generate a second session key.

In step S45, the session keys are determined whether they are matched. In practice, the first portable electronic device and the second portable electronic device performs a challenge-response authentication process to authenticate whether the first session key is matched with the second session key. If the first session key is matched with the second session key, step S46 is performed, which indicates successful authenticate, and step S48 is performed. As a result, the first portable electronic device and the second portable electronic device have accomplished secure pairing. If the first session key is not matched with the second session key, step S47 is performed, which indicates unsuccessful authentication, and step S42 is performed, during which the motion states of the first and second portable electronic devices are sensed again.

It is known from the above description and FIGS. 2 and 3 that a secure paring method for a portable electronic device according to the present disclosure includes a handshaking authentication process and a session key generation process, and establishing secure connection by employing the motion state information of a first portable electronic device and a second portable electronic device.

Therefore, the portable electronic device includes a first sensor and a second sensor that sense motion states of the portable electronic device and another portable electronic device, respectively, outputs the motion state of the portable electronic device to the another portable electronic device, receives a motion state of the another portable electronic device sensed by the another portable electronic device, and performs a handshaking authentication process and a session key generation process. Therefore, the secure pairing method for a portable electronic device can establish a second channel (i.e., an out-of-band channel), though the portable electronic device and another portable electronic device do not have shared secrets, and their secure connection is immune from the Man-in-the-middle Attack.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A portable electronic device, comprising:
a first sensor that senses a motion state of the portable electronic device and generates first motion state information;
a second sensor that senses a motion state of another portable electronic device and generates second motion state information;
a communication unit that outputs the first motion state information to the another portable electronic device and receives third motion state information and another session key output by the another portable electronic device, wherein the third motion state information indicates a motion state of the another portable electronic device sensed by the another portable electronic device; and
a control unit that compares the second motion state information with the third motion state information, enables the first and second sensors to sense the motion states of the portable electronic device and the another portable electronic device, respectively, if the second motion state information is matched with the third motion state information, processes the motion states and generates a session key, authenticates whether the session key is matched with the another session key, and enables the communication unit to communicate with another communication unit of the another portable electronic device if the session key is matched with the another session key.

2. The portable electronic device of claim 1, wherein the control unit employs a Hashing function to process the motion state of the portable electronic device sensed by the first sensor and generate a first random number and to process the motion state of the another portable electronic device sensed by the second sensor and generate a second random number, and generates the session key by connecting the first random number in series with the second random number.

3. The portable electronic device of claim 1, wherein the portable electronic device employs a challenge-response authentication process to authenticate whether the session key is matched with the another session key.

4. The portable electronic device of claim 1, wherein the control unit, when comparing the second motion state information with the third motion state information, transforms a reference coordinate of the second motion state information.

5. The portable electronic device of claim 1, further comprising a memory unit that records the first motion state information, the second motion state information and the third motion state information.

6. The portable electronic device of claim 1, wherein the second sensor is a depth image sensor.

7. A secure pairing method for a portable electronic device, comprising the followings steps of:
(1) enabling a first portable electronic device to sense a motion state of the portable electronic device, generate first motion state information and output the first motion state information to a second portable electronic device, enabling the first portable electronic device to sense a motion state of the second portable electronic device and generate second motion state information, enabling the second portable electronic device to sense a motion state of the second portable electronic device, generate third motion state information and output the third motion state information to the first portable electronic device, and enabling the second portable electronic device to sense a motion state of the first portable electronic device and generate fourth motion state information;
(2) enabling the first portable electronic device to receive the third motion state information, and enabling the second portable electronic device to receive the first motion state information;
(3) enabling the first portable electronic device to compare the second motion state information with the third motion state information, and enabling the second portable electronic device to compare the fourth motion state information with the first motion state information;
(4) enabling the first portable electronic device to sense the motion states of the first and second portable electronic devices, when the second motion state information is matched with the third motion state information, process the motion states, and generate a first session key, and enabling the second portable electronic device to sense the motion states of the second and first portable electronic devices, when the fourth motion state information is matched with the first motion state information, process the motion states, and generate a second session key; and
(5) enabling the first and the second portable electronic devices to authenticate whether the first session key is matched with the second session key, and enabling the first and second portable electronic devices to communicate with each other.

8. The secure pairing method of claim 7, wherein step (4) comprises:
(4-1) enabling the first portable electronic device to employ a Hashing function to process the motion state of the first portable electronic device and generate a first random number, and process the motion state of the second portable electronic device and generate a second random number, and enabling the second portable electronic device to employ the Hashing function to process the motion state of the second portable electronic device and generate a third random number, and process the motion state of the first portable electronic device and generate a fourth random number; and
(4-2) enabling the first portable electronic device to employ a specific mode to combine the first random number with the second random number and generate the first session key, and enabling the second portable electronic device to employ the specific mode to combine the third random number with the fourth random number and generate the second session key.

9. The secure pairing method of claim 7, further comprising, prior to step (3), enabling the first portable electronic device to transform a reference coordinate of the second motion state information, and enabling the second portable electronic device to transform a reference coordinate of the fourth motion state information.

10. The secure pairing method of claim 7, wherein in step (5) if the first session key is not matched with the second session key, the secure paring method returns to step (4).

11. The secure pairing method of claim 7, wherein in step (5) the first and second portable electronic devices employ a challenge-response authentication process to authenticate whether the first session key is matched with the second session key.
